(19) United States
(12) Patent Application Publication
(10) Pub. No.: US 2026/0141880 A1
(43) Pub. Date: May 21, 2026

(54) FOLDABLE GUITAR

(71) Applicants: Dongguan Midiplus Electronic Technology Co., Ltd., Dongguan (CN); Guangzhou Huancheng Cultural Media Co., Ltd., Guangzhou (CN)

(72) Inventors: Shaomin LIU, Dongguan (CN); Jin YANG, Dongguan (CN); Chaoyi ZHANG, Dongguan (CN); Shuo JIA, Guangzhou (CN); Haojun ZHENG, Guangzhou (CN); Li TIAN, Guangzhou (CN)

(21) Appl. No.: 19/449,835

(22) Filed: Jan. 15, 2026

(30) Foreign Application Priority Data
Jul. 24, 2025 (CN) 202521561207.6
Jul. 24, 2025 (CN) 202521561248.5

(51) Int. Cl. G10D 1/08

(52) U.S. Cl. CPC G10D 1/08

(57) ABSTRACT

A foldable guitar includes a body portion, a neck portion, a pivot mechanism, a plucking assembly and a fretting assembly. The plucking assembly is arranged on the body portion. The fretting assembly is arranged on the neck portion. A side of a bottom of the neck portion is hinged to a side of a top of the body portion through the pivot mechanism. The neck portion is configured to be rotated to lie against a side of the body portion. In a case that the neck portion is folded to lie against the side of the body portion, the plucking assembly and the fretting assembly are configured to face upward.

### CROSS-REFERENCE TO RELATED APPLICATIONS

This application claims the benefit of priority from Chinese Patent Application No. 202521561207.6 and No. 202521561248.5, both filed on Jul. 24, 2025. The content of the aforementioned application, including any intervening amendments thereto, is incorporated herein by reference in its entirety.

### TECHNICAL FIELD

This application relates to foldable guitars, and more particularly to a foldable guitar.

### BACKGROUND

Foldable guitars have emerged on the market for the convenience of carrying and storage. Chinese Patent Application No. 202322922833.0 disclosed a two-section foldable guitar, including a body portion, a neck portion and a pivot mechanism. This guitar can be folded to significantly decrease its overall length, improving the portability and facilitating storage. During the folding process, the neck portion is turned backward to lie against a rear end of the body portion, causing a relatively large thickness after folding. Moreover, considering the fact that the neck portion is generally provided with a fretting assembly, and the body portion is generally provided with a plucking assembly, such folding manner will cause either the fretting assembly or the plucking assembly to face down and be pressed when the two-section foldable guitar is horizontally placed after folded.

### SUMMARY

An object of the present disclosure is to provide a foldable guitar for addressing the existing problems. When the foldable guitar is folded, a length of the foldable guitar is shortened while not increasing a thickness of the foldable guitar. Moreover, when the foldable guitar is horizontally placed, a plucking assembly and a fretting assembly are not compressed due to its relatively small thickness.

In order to achieve the above objectives, the technical solution of the present disclosure is adopted herein.

A foldable guitar, comprising:
a body portion;
a neck portion;
a pivot mechanism;
a plucking assembly arranged on the body portion; and
a fretting assembly arranged on the neck portion;
wherein a side of a bottom of the neck portion is hinged to a side of a top of the body portion through the pivot mechanism;
the neck portion is configured to be rotated to lie against a side of the body portion; and
in response to a case that the neck portion is folded to lie against the side of the body portion, the plucking assembly and the fretting assembly are configured to face upward.

In some embodiments, the pivot mechanism comprises a pivot base and two double-end threaded studs inserted into the pivot base;
each of the two double-end threaded studs comprises a middle rod portion and two threaded end portions; each of the two double-end threaded studs is inserted into the pivot base via the middle rod portion; and each of the two threaded end portions is threadedly connected to a nut;
two sides of the middle rod portion are each provided with a pivot assembly; the pivot assembly comprises a connecting plate, a fixed washer and an elastic washer; the connecting plate is provided with a movable washer configured to be rotatably fitted onto a side of the middle rod portion; the fixed washer is configured to be fixedly fitted onto the side of the middle rod portion and to matchingly abut against the movable washer;
an end surface of the movable washer configured for abutting against the fixed washer is configured as a first undulating surface extending around an axial direction of the movable washer; and an end surface of the fixed washer configured for abutting against the movable washer is configured as a second undulating surface fitting the first undulating surface;
the elastic washer is configured to fit onto a side of the middle rod portion, and to abut against a side of the movable washer away from the fixed washer at least;
the movable washer, the fixed washer and the elastic washer are configured to be clamped between the middle rod portion and the nut; and
the connecting plate is connected to the body portion or the neck portion.

In some embodiments, each of the two double-end threaded studs is axially provided with a first through hole; a side surface of the middle rod portion is provided with a second through hole communicating with the first through hole; a cable-routing groove is formed in the pivot base; and second through holes of the two double-end threaded studs communicate with each other via the cable-routing groove.

In some embodiments, the pivot assembly further comprises a central washer and an end washer; the central washer and the end washer are fitted onto the middle rod portion; the central washer is configured to abut against the middle rod portion; and the end washer is configured to abut against the nut.

In some embodiments, the central washer, the movable washer, the fixed washer, the elastic washer and the end washer are sequentially arranged between the middle rod portion and the nut.

In some embodiments, the connecting plate is provided with a mounting hole.

In some embodiments, the connecting plate and the movable washer are arranged on the same plane.

In some embodiments, the connecting plate and the movable washer are configured to together form a L-shaped structure.

In some embodiments, the foldable guitar further comprises a fastening assembly; the fastening assembly comprises a female-end fastener, a male-end fastener and an unlocking component; the female-end fastener is arranged on the body portion; the male-end fastener is arranged on the neck portion; and
in response to a case that the foldable guitar is in an unfolded state, the female-end fastener is engaged with the male-end fastener, so as to prevent the neck portion from rotating; and the unlocking component is configured to disengage the female-end fastener from the male-end fastener, so as to allow the neck portion to rotate.

In some embodiments, the male-end fastener comprises a male-end body and a first hook; the first hook is arranged at a side of a bottom of the male-end body; the female-end fastener comprises a female-end body and a second hook; the second hook is arranged at a side of a top of the female-end body; and in response to a case that the female-end fastener is engaged with the male-end fastener, a top of the first hook is configured to abut against a bottom of the second hook.

In some embodiments, a first inclined portion is formed on a bottom of the first hook; an end of the first inclined portion close to the female-end fastener is higher than an end of the first inclined portion away from the female-end fastener; a second inclined portion is formed on a top of the second hook; and an end of the second inclined portion close to the male-end fastener is lower than an end of the second inclined portion away from the male-end fastener.

In some embodiments, the unlocking component comprises a sliding seat, a slider and a compression spring; the sliding seat is arranged on the body portion; the slider is slidably connected to the sliding seat along a horizontal direction; the compression spring is clamped between the sliding seat and the slider; and the female-end fastener is arranged on the slider.

In some embodiments, the unlocking component further comprises a pushing rod arranged on the slider.

In some embodiments, the sliding seat is provided with a sliding groove; the slider comprises an abutting portion and a guiding portion fitting the sliding groove; a first end of the compression spring is configured to abut against the sliding seat; and a second end of the compression spring is configured to abut against the abutting portion.

In some embodiments, the fastening assembly further comprises a guide groove and a guide pin; the guide groove is arranged on the body portion; the guide pin is arranged on the neck portion; and
in response to a case that the neck portion is rotatably unfolded, the guide pin is inserted into the guide groove.

In some embodiments, the guide pin is configured as a truncated-cone structure with a diameter decreasing from top to bottom.

In some embodiments, the foldable guitar further comprises a collapsible handle.

In some embodiments, the collapsible handle is hinged to the body portion; in response to a case that the collapsible handle is deployed, the collapsible handle is arranged on a side of the body portion; and in response to a case that the collapsible handle is stowed in a collapsed state, the collapsible handle is arranged on a front end or a rear end of the body portion.

Compared to the prior art, the present disclosure has the following beneficial effects.

The foldable guitar includes the body portion, the neck portion, the pivot mechanism, the plucking assembly and the fretting assembly. The plucking assembly is arranged on the body portion. The fretting assembly is arranged on the neck portion. The side of the bottom of the neck portion is hinged to the side of the top of the body portion through the pivot mechanism. The neck portion is configured to be rotated to lie against the side of the body portion. In response to a case that the neck portion is folded to lie against the side of the body portion, the plucking assembly and the fretting assembly are arranged upward.

A length of the foldable guitar is shortened by folding the neck portion to the side of the body portion, while not increasing a thickness of the foldable guitar. When the neck portion is folded to lie against the side of the body portion, the plucking assembly and the fretting assembly are configured to face upward. Moreover, when the foldable guitar is horizontally placed, the plucking assembly and the fretting assembly will not be compressed due to its relatively small thickness.

### BRIEF DESCRIPTION OF THE DRAWINGS

FIG. 1 structurally shows a body portion and a neck portion according to an embodiment of the present disclosure (in a collapsed state);

FIG. 2 structurally shows a body portion and a neck portion according to an embodiment of the present disclosure (in an unfolded state);

FIG. 3 structurally shows a pivot mechanism according to an embodiment of the present disclosure;

FIG. 4 structurally shows a double-end threaded stud and a pivot base according to an embodiment of the present disclosure;

FIG. 5 structurally shows a fastening assembly according to an embodiment of the present disclosure;

FIG. 6 is an enlarged view of point A in FIG. 5;

FIG. 7 structurally shows a collapsible handle according to an embodiment of the present disclosure (in an unfolded state); and

FIG. 8 structurally shows a collapsible handle according to an embodiment of the present disclosure (in a collapsed state).

In the figures: 1—body portion; 2—neck portion; 3—pivot mechanism; 31—pivot base; 311—cable-routing groove; 32—double-end threaded stud; 321—middle rod portion; 322—threaded end portion; 323—first through hole; 324—second through hole; 33—nut; 34—pivot assembly; 35—connecting plate; 351—mounting hole; 36—fixed washer; 37—elastic washer; 38—movable washer; 39—central washer; 40—end washer; 4—plucking assembly; 5—fretting assembly; 6—fastening assembly; 61—female-end fastener; 611—female-end body; 612—second hook; 613—second inclined portion; 62—male-end fastener; 621—male-end body; 622—first hook; 623—first inclined portion; 63—unlocking component; 631—sliding seat; 6311—sliding groove; 632—slider; 6321—abutting portion; 6322—guiding portion; 633—compression spring; 634—pushing rod; 64—guide groove; 65—guide pin; and 7—collapsible handle.

### DETAILED DESCRIPTION OF EMBODIMENTS

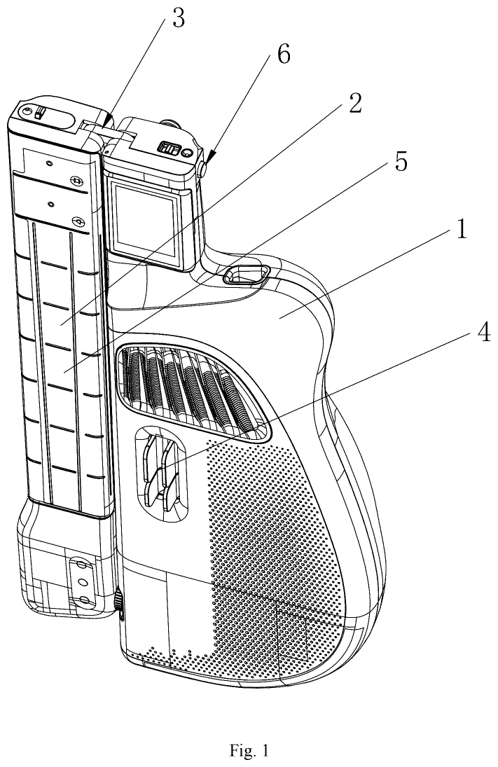

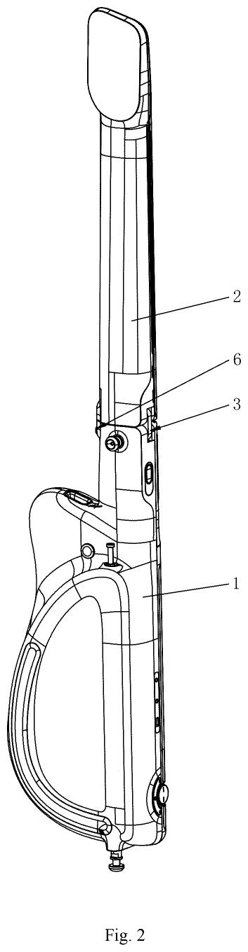

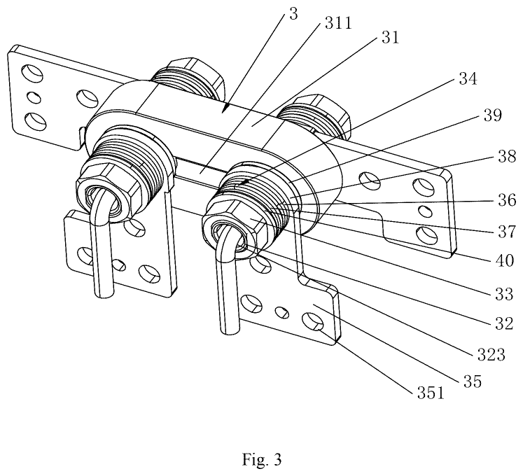

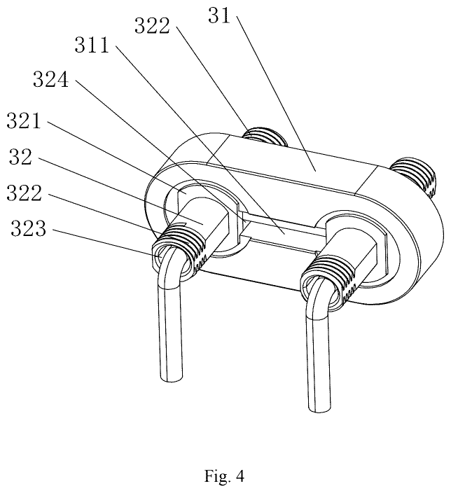

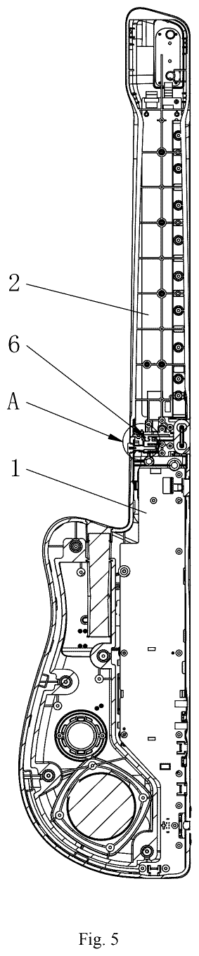

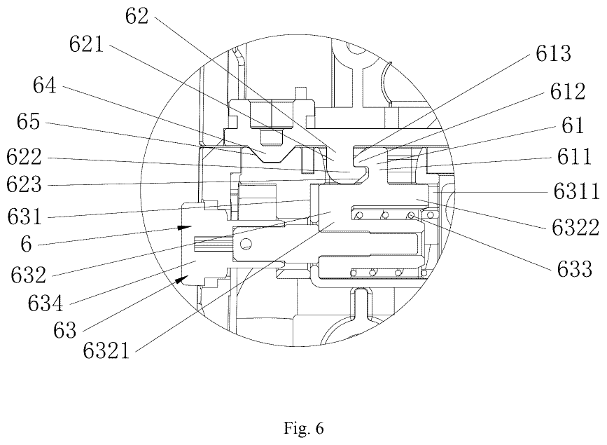

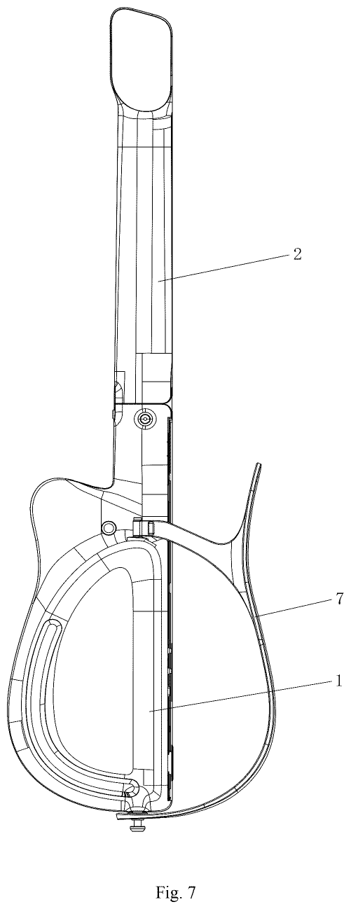

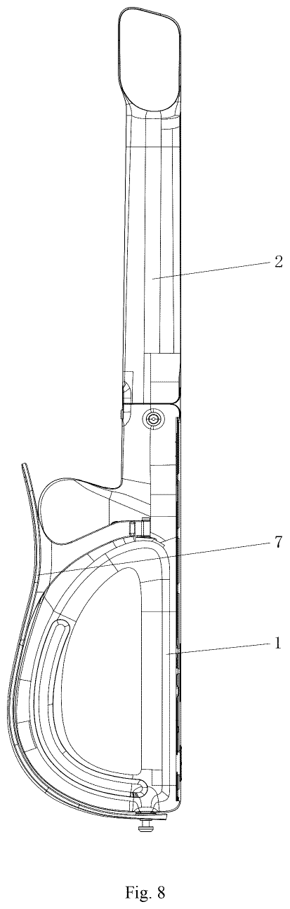

Referring to FIGS. 1-8, the present disclosure will be illustrated below in combination with the accompanying figures.

A foldable guitar includes a body portion 1, a neck portion 2, a pivot mechanism 3, a plucking assembly 4 and a fretting assembly 5. The plucking assembly 4 is arranged on the body portion 1. The fretting assembly 5 is arranged on the neck portion 2. A side of a bottom of the neck portion 2 is hinged to a side of a top of the body portion 1 through the pivot mechanism 3. The neck portion 2 is configured to be rotated to lie against a side of the body portion 1. In a case that the neck portion 2 is folded to lie against the side of the body portion 1, the plucking assembly 4 and the fretting assembly 5 are configured to face upward.

Compared to the prior art, a length of the foldable guitar is shortened by folding the neck portion 2 to the side of the body portion 1, while not increasing a thickness of the foldable guitar. When the neck portion 2 is folded to lie against the side of the body portion 1, the plucking assembly 4 and the fretting assembly 5 are configured to face upward. Moreover, when the foldable guitar is horizontally placed, the plucking assembly 4 and the fretting assembly 5 are not compressed due to its relatively small thickness.

In some embodiments, the pivot mechanism 3 includes a pivot base 31 and two double-end threaded studs 32 inserted into the pivot base 31. Each of the two double-end threaded studs 32 includes a middle rod portion 321 and two threaded end portions 322. Each of the two double-end threaded studs 32 is inserted into the pivot base 31 via the middle rod portion 321. Each of the two threaded end portions 322 is threadedly connected to a nut 33. Two sides of the middle rod portion 321 are each provided with a pivot assembly 34. The pivot assembly 34 includes a connecting plate 35, a fixed washer 36 and an elastic washer 37. A mounting hole 351 is arranged on the connecting plate 35. The connecting plate 35 is connected to the body portion 1 or the neck portion 2 via the mounting hole 351. The connecting plate 35 is provided with a movable washer 38 configured to be rotatably fitted onto a side of the middle rod portion 321. The fixed washer 36 is configured to fixedly fit onto the side of the middle rod portion 321 and to matchingly abut against the movable washer 38. An end surface of the movable washer 38 configured for abutting against the fixed washer 36 is configured as a first undulating surface extending around an axial direction of the movable washer 38.

An end surface of the fixed washer 36 configured for abutting against the movable washer 38 is configured as a second undulating surface fitting the first undulating surface. The elastic washer 37 is configured to fit onto a side of the middle rod portion 321, and to abut against a side of the movable washer 38 away from the fixed washer 36 at least. The movable washer 38, the fixed washer 36 and the elastic washer 37 are configured to be clamped between the middle rod portion 321 and the nut 33. The connecting plate 35 is connected to the body portion 1 or the neck portion 2.

A working principle of the pivot mechanism 3 provided herein is similar to that of a pivot mechanism disclosed in Chinese Patent Application No. 202322922833.0. For the sake of brevity, there are no more elaborations. A difference between the pivot mechanism 3 provided herein and it lies in that it includes four threaded studs. However, the present disclosure adopts the two double-end threaded studs 32 rather than four threaded studs, such that the number of components is relatively small, facilitating an assembly. Due to a connecting structure having fewer screw heads and shaft holes, it is more conducive to making the pivot base 31 thinner, thereby making the foldable guitar thinner.

In some embodiments, each of the two double-end threaded studs 32 is axially provided with a first through hole 323. A side surface of the middle rod portion 321 is provided with a second through hole 324 communicating with the first through hole 323. A cable-routing groove 311 is formed in the pivot base 31. Second through holes 324 communicate with each other via the cable-routing groove 311. Through the above arrangements, a wire is threaded into the first through hole 323 of one of the two double-end threaded studs 32, then passes sequentially through the second through hole 324 of one of the two double-end threaded studs 32, the cable-routing groove 311 of the pivot base 31 and the second through hole 324 of the other of the two double-end threaded studs 32, before finally exiting from the first through hole 323 of the other of the two double-end threaded studs 32. As a consequence, the body portion 1 is electrically connected to the neck portion 2, so as to enable a hidden wiring and a low risk of wire damage.

In some embodiments, the pivot assembly 34 further includes a central washer 39 and an end washer 40. The central washer 39 and the end washer 40 are configured to be fitted onto the middle portion 321. The central washer 39 is configured to abut against the middle rod portion 321. The end washer 40 is configured to abut against the nut 33. Through the above arrangements, it ensures a stable torque resistance and reduces friction, thereby guaranteeing a smoother overall rotation.

In some embodiments, the central washer 39, the movable washer 38, the fixed washer 36, the elastic washer 37 and the end washer 40 are sequentially arranged between the middle rod portion 321 and the nut 33.

Compared to a vertical arrangement of a connecting plate and a movable washer in the prior art, the connecting plate 35 and the movable washer 38 provided herein are arranged on the same plane, thereby facilitating an easy fabrication and making the foldable guitar thinner.

If the connecting plate 35 has a small diameter, a connecting strength will be not enough. In the existing technologies, a connecting plate and a movable washer have a large diameter. Compared to the prior art, the present disclosure adopts the connecting plate 35 with a large diameter and the movable washer 38 with a small diameter. The connecting plate 35 and the movable washer 38 are configured to form a L-shaped structure, such that the foldable guitar is more compact and smaller, saving materials and satisfying the requirement of the connecting strength.

In some embodiments, the foldable guitar further includes a fastening assembly 6. The fastening assembly 6 includes a female-end fastener 61, a male-end fastener 62 and an unlocking component 63. The female-end fastener 61 is arranged on the body portion 1. The male-end fastener 62 is arranged on the neck portion 2. In a case that the foldable guitar is in an unfolded state, the female-end fastener 61 is engaged with the male-end fastener 62, so as to prevent the neck portion 2 from rotating. The unlocking component 63 is configured to disengage the female-end fastener 61 from the male-end fastener 62, so as to allow the neck portion 2 to rotate.

Compared to the prior art, the foldable guitar further includes the fastening assembly 6. In a case that the foldable guitar is in an unfolded state, the female-end fastener 61 is engaged with the male-end fastener 62, so as to prevent the neck portion 2 from rotating, thereby ensuring the foldable guitar to be stably unfolded. The unlocking component 63 is configured to disengage the female-end fastener 61 from the male-end fastener 62, so as to allow the neck portion 2 to rotate. The neck portion 2 provided herein is configured to facilitate folding and unfolding, so as to prevent the neck portion 2 from shaking or mistakenly turning during performance, enable a foldable function and simultaneously ensure a feel and effect of the performance.

In some embodiments, the male-end fastener 62 includes a male-end body 621 and a first hook 622. The first hook 622 is arranged at a side of a bottom of the male-end body 621. The female-end fastener 61 includes a female-end body 611 and a second hook 612. The second hook 612 is arranged at a side of a top of the female-end body 611. In a case that the female-end fastener 61 is engaged with the male-end fastener 62, a top of the first hook 622 is configured to abut against a bottom of the second hook 612. Through the above arrangements, the foldable guitar is stably unfolded, such that it fails to rotate. Consequently, the above arrangements prevent the neck portion 2 from shaking or mistakenly turning during performance.

In some embodiments, a first inclined portion 623 is formed on a bottom of the first hook 622; an end of the first inclined portion 623 close to the female-end fastener 61 is higher than an end of the first inclined portion 623 away from the female-end fastener 61; a second inclined portion 613 is formed on a top of the second hook 612; and an end of the second inclined portion 613 close to the male-end fastener 62 is lower than an end of the second inclined portion 613 away from the male-end fastener 62. Through the above arrangements, the male-end fastener 62 is directly engaged with the female-end fastener 61 downward.

In some embodiments, the unlocking component 63 includes a sliding seat 631, a slider 632 and a compression spring 633. The sliding seat 631 is arranged on the body portion 1. The slider 632 is slidably connected to the sliding seat 631 along a horizontal direction. The compression spring 633 is clamped between the sliding seat 631 and the slider 632. The female-end fastener 61 is arranged on the slider 632. The slider 632 is pressed to drive the female-end fastener 61 to slide toward a side away from the male-end fastener 62, such that the female-end fastener 61 is disengaged from the male-end fastener 62. When the male-end fastener 62 is rotated upward, the neck portion 2 is rotated upward, causing the neck portion 2 to be rotated and folded. When the slider 632 is released, the slider 632 is slidably reset under a pushing action of the compression spring 633.

In some embodiments, the unlocking component 63 further includes a pushing rod 634 arranged on the slider 632. The pushing rod 634 is configured to easily press the slider 632, thereby facilitating an unlocking of the female-end fastener 61 and the male fastener 62.

In some embodiments, the sliding seat 631 is provided with a sliding groove 6311. The slider 632 includes an abutting portion 6321 and a guiding portion 6322 fitting the sliding groove 6311. A first end of the compression spring 633 is configured to abut against the sliding seat 631. A second end of the compression spring 633 is configured to abut against the abutting portion 6321. When the slider 632 is pressed, the guiding portion 6322 of the slider 632 is slidably connected to the sliding groove 6311 of the sliding seat 631 to enable cooperation. This cooperation can prevent the slider 632 from shifting during sliding and enable a better sliding.

In some embodiments, the fastening assembly 6 further includes a guide groove 64 and a guide pin 65. The guide groove 64 is arranged on the body portion 1. The guide pin 65 is arranged on the neck portion 2. In a case that the neck portion 2 is rotatably unfolded, the guide pin 65 is inserted into the guide groove 64. A cooperation of the guide groove 64 and the guide pin 65 can achieve a positioning function, making it easier for the male-end fastener 62 to be aligned and engaged with the female-end fastener 61.

In some embodiments, the guide pin 65 is configured as a truncated-cone structure with a diameter decreasing from top to bottom, so as to allow the guide pin 65 to be aligned with and inserted into the guide groove 64.

Compared to the prior art, the foldable guitar further includes a collapsible handle 7. The collapsible handle 7 is hinged to the body portion 1. In a case that the collapsible handle 7 is deployed, the collapsible handle 7 is arranged on a side of the body portion 1. In a case that the collapsible handle 7 is stowed in a collapsed state, the collapsible handle 7 is arranged on a front end or a rear end of the body portion 1. Through the above arrangements, the collapsible handle 7 is flipped to a side close to the body portion 1 to achieve folding. Not only can it enhance the convenience of carrying and holding the foldable guitar provided herein, but also when not in use, the collapsible handle 7 can be folded, reducing the space required for the overall shape and making it easier to store.

In some embodiments, the collapsible handle 7 also can achieve unfolding and folding through a sliding manner. Specifically, the collapsible handle 7 is slidably arranged on the body portion 1 along a left direction or a right direction. The collapsible handle 7 is pulled to a side away from the body portion 1 to achieve unfolding. The collapsible handle 7 is pushed and pulled toward a side close to the body portion 1 to achieve folding. The working principle is that the neck portion 2 is flipped upward to unfold the foldable guitar, and the neck portion 2 is flipped downward to fold the foldable guitar.

Compared to the prior art, a length of the foldable guitar is shortened by folding the neck portion 2 to the side of the body portion 1, while not increasing a thickness of the foldable guitar. When the neck portion 2 is folded to lie against the side of the body portion 1, the plucking assembly 4 and the fretting assembly 5 are configured to face upward. Moreover, when the foldable guitar is horizontally placed, the plucking assembly 4 and the fretting assembly 5 are not compressed due to its relatively small thickness.

Obviously, provided herein are merely preferable embodiments of the present disclosure, which are not intended to limit the present disclosure. It should be understood that various modifications, changes and equivalent replacements made by those skilled in the art without departing from the spirit of the present disclosure shall fall within the scope of the present disclosure defined by the appended claims.

What is claimed is:

1. A foldable guitar, comprising:
a body portion;
a neck portion;
a pivot mechanism;
a plucking assembly arranged on the body portion; and
a fretting assembly arranged on the neck portion;
wherein a side of a bottom of the neck portion is hinged to a side of a top of the body portion through the pivot mechanism;
the neck portion is configured to be rotated to lie against a side of the body portion; and
in response to a case that the neck portion is folded to lie against the side of the body portion, the plucking assembly and the fretting assembly are configured to face upward.

2. The foldable guitar of claim 1, wherein the pivot mechanism comprises a pivot base and two double-end threaded studs inserted into the pivot base;
each of the two double-end threaded studs comprises a middle rod portion and two threaded end portions; each of the two double-end threaded studs is inserted into the pivot base via the middle rod portion; and each of the two threaded end portions is threadedly connected to a nut;
two sides of the middle rod portion are each provided with a pivot assembly; the pivot assembly comprises a connecting plate, a fixed washer and an elastic washer; the connecting plate is provided with a movable washer configured to be rotatably fitted onto a side of the middle rod portion; the fixed washer is configured to be fixedly fitted onto the side of the middle rod portion and to matchingly abut against the movable washer;
an end surface of the movable washer configured for abutting against the fixed washer is configured as a first undulating surface extending around an axial direction of the movable washer; and an end surface of the fixed washer configured for abutting against the movable washer is configured as a second undulating surface fitting the first undulating surface;
the elastic washer is configured to fit onto a side of the middle rod portion, and to abut against a side of the movable washer away from the fixed washer at least;
the movable washer, the fixed washer and the elastic washer are configured to be clamped between the middle rod portion and the nut; and
the connecting plate is connected to the body portion or the neck portion.

3. The foldable guitar of claim 2, wherein each of the two double-end threaded studs is axially provided with a first through hole; a side surface of the middle rod portion is provided with a second through hole communicating with the first through hole; a cable-routing groove is formed in the pivot base; and second through holes of the two double-end threaded studs communicate with each other via the cable-routing groove.

4. The foldable guitar of claim 2, wherein the pivot assembly further comprises a central washer and an end washer; the central washer and the end washer are fitted onto the middle rod portion; the central washer is configured to abut against the middle rod portion; and the end washer is configured to abut against the nut.

5. The foldable guitar of claim 4, wherein the central washer, the movable washer, the fixed washer, the elastic washer and the end washer are sequentially arranged between the middle rod portion and the nut.

6. The foldable guitar of claim 2, wherein the connecting plate is provided with a mounting hole.

7. The foldable guitar of claim 2, wherein the connecting plate and the movable washer are arranged on the same plane.

8. The foldable guitar of claim 7, wherein the connecting plate and the movable washer are configured to together form a L-shaped structure.

9. The foldable guitar of claim 1, further comprising:
a fastening assembly;
wherein the fastening assembly comprises a female-end fastener, a male-end fastener and an unlocking component; the female-end fastener is arranged on the body portion; the male-end fastener is arranged on the neck portion; and
in response to a case that the foldable guitar is in an unfolded state, the female-end fastener is engaged with the male-end fastener, so as to prevent the neck portion from rotating; and the unlocking component is configured to disengage the female-end fastener from the male-end fastener, so as to allow the neck portion to rotate.

10. The foldable guitar of claim 9, wherein the male-end fastener comprises a male-end body and a first hook; the first hook is arranged at a side of a bottom of the male-end body; the female-end fastener comprises a female-end body and a second hook; the second hook is arranged at a side of a top of the female-end body; and in response to a case that the female-end fastener is engaged with the male-end fastener, a top of the first hook is configured to abut against a bottom of the second hook.

11. The foldable guitar of claim 10, wherein a first inclined portion is formed on a bottom of the first hook; an end of the first inclined portion close to the female-end fastener is higher than an end of the first inclined portion away from the female-end fastener; a second inclined portion is formed on a top of the second hook; and an end of the second inclined portion close to the male-end fastener is lower than an end of the second inclined portion away from the male-end fastener.

12. The foldable guitar of claim 9, wherein the unlocking component comprises a sliding seat, a slider and a compression spring; the sliding seat is arranged on the body portion; the slider is slidably connected to the sliding seat along a horizontal direction; the compression spring is clamped between the sliding seat and the slider; and the female-end fastener is arranged on the slider.

13. The foldable guitar of claim 12, wherein the unlocking component further comprises a pushing rod arranged on the slider.

14. The foldable guitar of claim 12, wherein the sliding seat is provided with a sliding groove; the slider comprises an abutting portion and a guiding portion fitting the sliding groove; a first end of the compression spring is configured to abut against the sliding seat; and a second end of the compression spring is configured to abut against the abutting portion.

15. The foldable guitar of claim 1, wherein the fastening assembly further comprises a guide groove and a guide pin; the guide groove is arranged on the body portion; the guide pin is arranged on the neck portion; and
in response to a case that the neck portion is rotatably unfolded, the guide pin is inserted into the guide groove.

16. The foldable guitar of claim 15, wherein the guide pin is configured as a truncated-cone structure with a diameter decreasing from top to bottom.

17. The foldable guitar of claim 1, wherein the foldable guitar further comprises a collapsible handle.

18. The foldable guitar of claim 17, wherein the collapsible handle is hinged to the body portion; in response to a case that the collapsible handle is deployed, the collapsible handle is arranged on a side of the body portion; and in response to a case that the collapsible handle is stowed in a collapsed state, the collapsible handle is arranged on a front end or a rear end of the body portion.
